(19) United States
(12) Patent Application Publication
(10) Pub. No.: US 2004/0069634 A1
(43) Pub. Date: Apr. 15, 2004

(54) Vapor phase method for producing silane coatings

(76) Inventor: David K. Hanzel, Palo Alto, CA (US)

Correspondence Address: Amersham Biosciences Corp, 800 Centennial Avenue, Piscataway, NJ, 08855, US

(21) Appl. No.: 10/269,535

(22) Filed: Oct. 11, 2002

(51) Int. Cl. G01N 27/26; G01N 27/447

(52) U.S. Cl. 204/454

(57) ABSTRACT

A method for coating a substrate with silane that comprises contacting in an inert environment a substrate with a vapor containing a bifunctional silane, preferably a bifunctional silane containing an acrylic functionality. The method may further comprise the step of attaching a coating of polyacrylamide to the acrylic functionality by in-situ polymerization or the step of immobilizing acrylic-modified molecules by copolymerization with the acrylic functionality of the bifunctional silane. The substrate may be a capillary, a microchip, a bead, or a slide, preferably of glass. A substrate coated using the instant method, as well as a method for reducing EOF in capillaries used for electrophoresis are also disclosed.

### BACKGROUND OF THE INVENTION

1. Field of the Invention

The instant disclosure pertains to a vapor phase method for producing uniform and robust silane coating's which reduce electroosmotic flow and are particularly suitable for use in capillary electrophoresis. The instant disclosure also pertains to silane coatings produced by this method.

2. Description of Related Art

Capillary electrophoresis (“CE”) is a fast and efficient method for separating molecules such as nucleic acids and proteins according to size. Unfortunately, interaction of the analyte with the inner surface of the silica glass capillary contributes significantly to electroosmotic flow (“EOF”). In nucleic acid separation applications, high EOF can cause migration of the separation matrix out of the capillary and adsorption of protein contaminants and dyes to the capillary surface. To achieve high resolution and long read length, EOF must be supressed. EOF suppression generally involves neutralizing the surface charge associated with the interior surface of the glass capillary.

Several methods for suppressing EOF exist. For example, the addition of background electrolytes with suitable characteristics to the running buffer has been somewhat successful in reducing EOF. Likewise, certain coatings produced by the adsorption of a polymer present in the form of an aqueous solution have been found efficient in suppressing EOF. These coatings are most efficient when a small amount of polymer is dissolved in the running buffer, the polymer can also be easily removed from the surface with a water flush. Alternatively, one may reduce EOF by coating the capillary surface through a covalent silanol derivatization. U.S. Pat. No. 4,680,201 to Hjerten et al. discloses a coating for reducing EOF which is prepared by first contacting the substrate with a solution of a monomeric bifunctional compound which includes a first functional group capable of covalent attachment to the substrate and a second functional group capable of polymerization, and subsequently reacting the covalently bound second functional group with free monomer to form a coating. The fluid phase application of the silane makes it is difficult to obtain a uniform coating using this method.

Multiple capillary array technology, where as many as 384 capillaries are handled at a same time requires very simple and reliable coating procedures. The difficulties associated with performing chemical derivatization on silica micro-channels represent a significant obstacle to the development of innovative techniques such as micro-chip technology. Most methods for coating fused silica capillaries are not robust and repeatable enough to consistently provide qualified capillary arrays. This results in the need to functionally test all arrays before they can be shipped to customers as well as a high failure rate and scrap costs. In addition, bulk coating of capillary stock before it is assembled into an array exposes the wall coating to heat and light during the window burning process.

As the above discussion suggests, improvements are still possible and desirable in the area of surface coatings for suppressing EOF. In particular, a coating is needed for suppressing EOF which is uniform and which preferably adheres strongly to the surface. A method is also needed for generating such a coating in a reproducible manner. Ideally, such a method would be easy to use with capillary arrays, chips, or other substrates including, micro-fabricated separation vessels or reaction channels and fused silicon dioxide. These and other related matters are addressed in greater detail below.

### SUMMARY OF THE INVENTION

Accordingly, it is the object of the invention to provide surface coatings for suppressing EOF that are uniform, reproducible and adhere strongly. This and other objectives were met by the present invention, which relates in a first embodiment to a method for coating a substrate with silane that comprises contacting in an inert environment the substrate with a vapor containing a bifunctional silane. A second embodiment relates to the method wherein the inert environment is a nitrogen gas. A third embodiment relates to the method wherein the bifunctional silane contains an acrylic functionality and a fourth embodiment relates to the method wherein the bifunctional silane is 3-methacryloxypropyltrimethoxysilane.

Three further embodiments of the invention relate to the method wherein the substrate is a glass capillary, a glass bead, or a glass slide. In another aspect, the present invention relates to the coated substrate, coated according to the method above.

Another aspect of the invention relates to the method further comprising the step of attaching a thin coating of linear polyacrylamide to the acrylic functionality by in-situ polymerization. A further aspect of the invention relates to the method further comprising the step of immobilizing acrylic-modified molecules by copolymerization with the acrylic functionality of the bifunctional silane. A still further aspect of the present invention relates to a method for reducing electroosmotic flow in glass capillaries used for electrophoresis that comprises: a) contacting in an inert environment a substrate with a vapor containing a bifunctional silane containing an acrylic functionality; and b) incorporating a thin coating of linear polyacrylamide to the acrylic functionality by in-situ polymerization.

The above objects and features of the invention will become more fully apparent when the following detailed description of the invention is read in conjunction with the accompanying figures.

### BRIEF DESCRIPTION OF THE DRAWINGS

FIG. 1 shows a custom built apparatus that holds 12 capillary arrays during the multiple processing steps. This rack protects the capillaries from breakage due to excessive handling and facilitates subsequent processing. In this view the arrays are prepared for Pretreatment by connecting the Pressure Vessel on the rack (silver cylinder in the right foreground of the image) to the pump and solutions used for pretreating arrays prior to the vapor deposition. A Toshiba Prosec T1 MDR16 Program logic controller (white box in rear of FIG. 1) controls the process. The bottles dispense the required chemicals & the quick-connect connected to the Pressure Vessel at the anode end delivers the chemicals to the arrays.

FIG. 2 shows an apparatus that can be used for vapor deposition. The apparatus comprises a vacuum oven from Lindberg/Blue, Model # V01218SA. A program logic controller from Horner Electric, Part #IC 300OCS200M Controls the program. During vapor deposition the rack, with capillary arrays shown in FIG. 1, is placed inside the vacuum oven.

FIG. 3 shows the rack, with capillary arrays, connected to the syringe pump used to introduce the acrylamide solution for In-situ polymerization.

FIG. 4 depicts one embodiment of an early apparatus that was used to produce the vapor phase coatings of the instant disclosure.

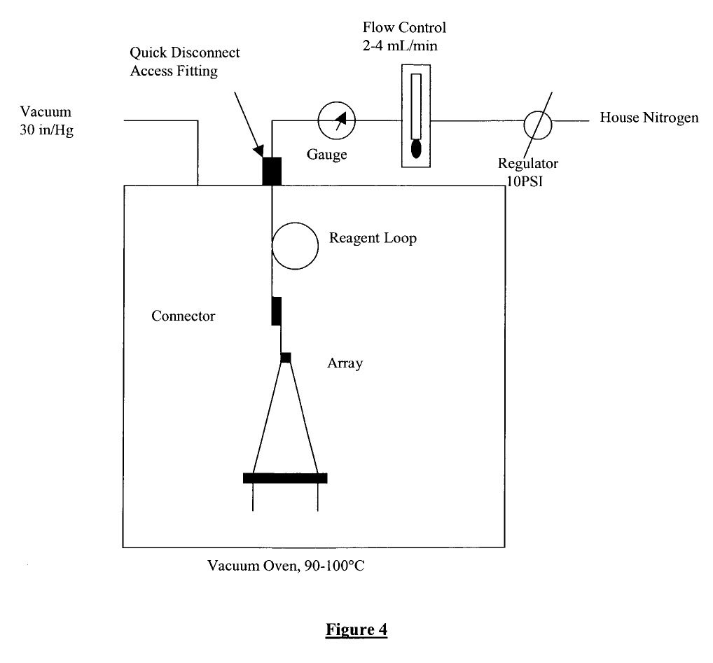

FIG. 5 is a plot of average readlength in base pairs versus run number for a capillary electrophoresis column containing the vapor phase coating of the instant disclosure which was used to sequence nucleic acids.

FIG. 6 is a collection of images acquired with a fluorescent confocal microscope (Sarastro 2000, Molecular Dynamics, Sunnyvale Calif.) configured to image the fluorescent dye Cy3 (Amersham Biosciences), signal from the dye appears black in these images. The central 4 images are optical cross sections of glass capillaries that were subjected to four different treatments. The surrounding images are projections, functionally a 2 dimensional representation of the 3 dimensional data collected by the microscope; to the left and right of the central images are projections along the long axis of the capillaries showing the inner (smaller radius) and outer (larger) surfaces. Above #1 and below #4 are projections orthogonal to the long axis showing the coating on the inner surface of the capillary.

FIG. 7 shows two different capillaries. The upper image is an en face, maximum intensity projection of non-washed capillary, the lower image is a capillary that was flushed with water before drying and silanizaton.

FIG. 8 is a rotation projection series, at 10-degree increments, of the dataset shown en face in the upper panel of FIG. 6. The scale bar represents 20 microns.

### DETAILED DESCRIPTION OF THE INVENTION

Disclosed is a vapor phase method for attaching a bifunctional silane to a substrate via a Si—O—Si bond. Preferably, the distal end of the bifunctional silane contains an acrylic group that may be incorporated into a thin coating of polymer, such as linear polyacrylamide, by in situ polymerization. Silane coatings produced using the instant method are robust, uniform, and have been shown to reduce EOF in applications such as Capillary Array Electrophoresis (“CAE”).

The silane coating may be vapor deposited onto any type of substrate, such as glass or polymer. Preferably, the substrate is a glass such as fused silica. The substrate may take the configuration of a slide, microchip, bead, or capillary. Most preferably, the substrate is a fused silica capillary, such as those capillaries used for CAE which are commercially available from Polymicro Technologies of Phoenix, Ariz. In order to remove any possible impurities and improve the efficacy of coating, the substrate may be flushed with water and incubated in the basic solution for about 10 minutes, then flushed 3 times with deionized water and dried with high pressure nitrogen.

Coating of the substrate with the bifunctional group can be the desired end result or can facilitate the attachment of other material to the glass surface. In general, the bifunctional silane contains a first functional group capable of attaching to the substrate and a second functional group capable of undergoing in situ polymerization with the desired monomer to form a polymer coating. Examples of suitable first functional groups include, but are not limited to, methoxy, acetoxy, ethoxy, methoxyethoxy, or chloro functional groups capable of reacting with the free hydroxyl groups in substrates such as glass. Examples of suitable second functional groups include, but are not limited to, acryl, acryloyl, methacryl, allyl or vinyl, which are capable of being polymerized. In general, any bifunctional silane capable of being vaporized may be used. Examples of bi-functional silane's suitable for use in the instant disclosure include 3-methacryloxypropyltrimethylsilane, γ-methacryloxypropyltrimethoxysilane, vinyltriacetoxysilane, vinyltri (β-methoxyethoxy) silane, vinyltrichlorosilane, and methylvinyldichlorosilane. Most preferably, the bi-functional silane is 3-methacryloxypropyltrimethylsilane.

Methods and Materials

Reagents

Acrylamide, 1% (Teknova A3335).

10% Ammonium persulfate (“APS”), (Sigma, S-3678).

N,N,N′,N′-tetramethlyethylenediamine (“TEMED”) (Sigma, T-9281)

The silane used in the following examples was 3-methacryloxypropyltrimethylsilane, Obtained from Sigma Chemical, M6514.

Unless otherwise stated, deionized water (available from Technova) was used in all of the following examples.

Equipment

Capillary arrays comprised of flexible, fused silica capillary tubing having an internal diameter of 75 μm, an outside diameter of 200 μm, and an outside coating of polyimide to protect against abrasion, commercially available from Polymicro Technologies, Phoenix, Ariz.

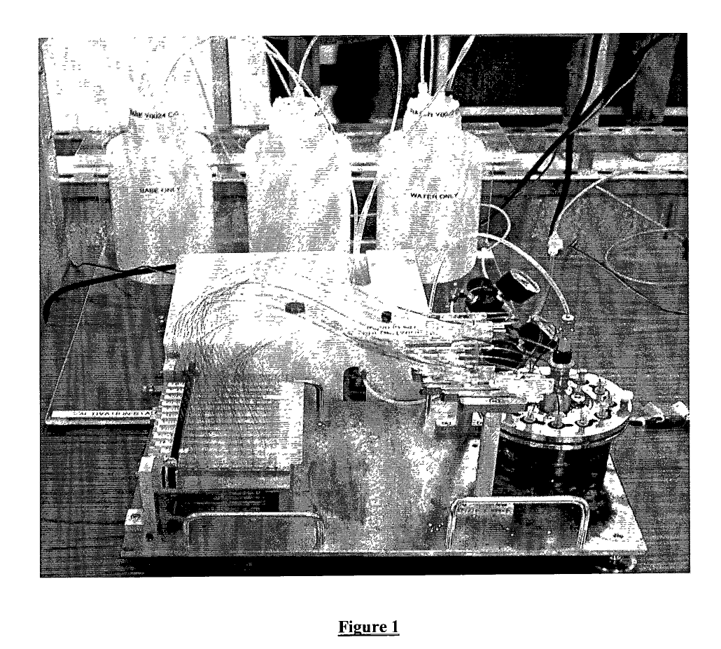

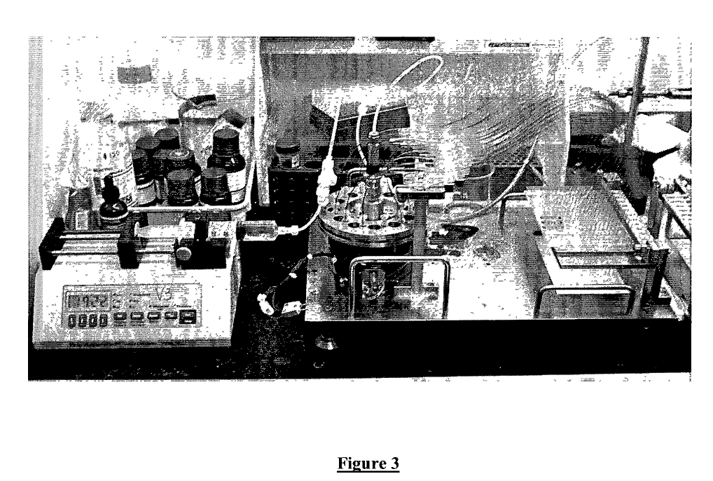

To minimize the handling and breakage of the fragile capillaries a custom built apparatus that holds 12 capillary arrays has been fabricated. The rack (shown in FIGS. 1 and 3) facilitates the introduction of reagents, and placement in a vacuum oven. The capillary arrays remain attached to the rack throughout the entire coating process.

Pretreatment of Arrays

Ensure work area is clean and free of debris. Fill all of the containers (shown in FIG. 1) to the mark with freshly prepared reagents. Install the arrays on the rack as shown in FIG. 1. Lock the anode cover after installation. Place the solvent collecting tray under the cathode end. Connect the quick connect to the anode end of the pressure vessel (in the center, see FIG. 1) listen for the “click” to know the connection is complete. Turn the on/off/switch to the “ON” position. Ensure all the arrays are flushing by watching drops form on the end of all the capillaries. A red light on the second row of the program logic controller will cycle through the following sequence;

| water flush | 5 min |
|---|---|
| N2 purge | 2 min |
| base flush | 10 min |
| The program pauses while the user rinses off the base from the | |
| tubing & the Pressure Vessel | |
| N2 purge | 5 min |
| water flush | 10 min |
| N2 purge | 5 min |
| water flush | 10 min |
| N2 purge | 5 min |
| water flush | 10 min |
| N2 purge | 5 min |

end of process after about 80 minutes.

At the end of the process, turn the on/off switch to “off”. Disconnect the quick connect from the Pre-treatment station.

Silanization of Arrays

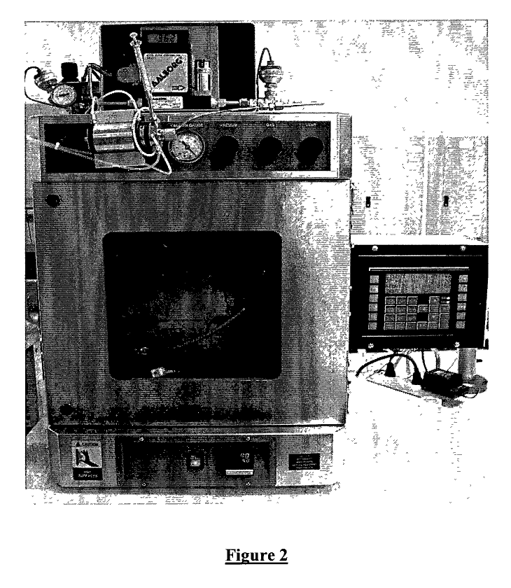

Vapor phase coating takes place by exposing the substrate to the bifunctional silane in vapor phase. In practice vapor phase conditions are maintained by placing the capillaries in a vacuum oven thus reducing the pressure required for adequate flow rates. For example, capillary arrays are mounted in the rack (FIGS. 1 and 3) in the vacuum oven (FIG. 2, pre heated to 90° C.), with one end of the capillaries open and thus equilibrated with the vacuum. The other end of the capillary is attached to the pressure vessel from which the silane vapor is introduced. A vacuum is applied and the system allowed to stabilize for a few minutes. Adjustments are made to provide a vacuum of approximately 20-40 in/Hg generating a flow of approximately 2-4 ml/min. This flow is maintained through the capillaries for approximately 15 minutes to remove any excess water. A small amount of water will always remain on the surface of the glass. In general, 50 to 70 μl of bi-functional silane is used to coat approximately ˜40,000,000,000 square microns. Prepare 460 ul of Silane/Acetonitrile solution using 60 ul of Silane & 400 ul of Acetonitrile; this solution is then introduced with a glass syringe into the injection port on the oven. Although the vapor phase coating process may take place at room temperature, preferably, the process takes place at about 70 to about 115° C. Most preferably, the process takes place at about 90° C. Program will run for 75 minutes. Remove the pressure vessel from the oven & cool to room temperature.

In-Situ Polymerization

In general, the bifunctional silane coating may be polymerized with any monomer capable of polymerizing with the second functional group contained on the bi-functional silane. Preferred monomers include acrylamide, acryloylmorpholine, ethylene glycol methacrylate, and vinyl alcohol, which form polymeric layers such as polyacrylamide, polyacryloylmorpholine, poly (ethylene glycol methacrylate), polyvinyl pyrrolidone, polyvinyl alcohol, etc. An especially preferred monomer is acrylamide. The polymerization occurs by contacting the monomers with the second functional group contained on the bi-functional silane coating. The following describes a process for attaching a coating of polyacrylamide to the acrylic functionality.

Remove a tube of 1% acrylamide solution from the refrigerator and place in a room temperature water bath. Check the expiration date and discard if past date. Caution: Wear latex gloves and lab coat while handling acrylamide solution, it is a neurotoxin. Pipette out 20 ml of the 1% acrylamide solution into a flask. Add 200 ul of 10% Ammonium Per Sulfate to the flask. To degas the acrylamide solution, connect the flask to house vacuum and swirl the flask until the solution stops bubbling. Add 10 ul of TEMED, and gently swirl to mix. Fill a 30 ml syringe with the acrylamide solution and with tubing to the pressure vessel as shown in FIG. 2, pump the acrylamide solution through the capillary arrays by pressing the plunger of the syringe until droplets of fluid are seen at the end of the arrays. Set the syringe pump for 12 ml/hr and press start. The pump indicator light will flash if started correctly. The program will run for 60 minutes. After run is ended, press the start button to stop the program. The polymerization reaction is then terminated by flushing the arrays with 1% EDTA for 1 hour. Prepare a 30 ml syringe with 15 ml of 1% EDTA solution. Remove the used syringe and replace with the syringe with the 1% EDTA solution. Set syringe pump for 12 mL/hr and press start. The pump indicator light will flash if started correctly. Program will run for 60 minutes. The arrays are then blown dry using Nitrogen. The arrays can now be used to run samples for separation. In addition to bare-glass arrays, this method effectively recovers used capillary arrays.

The instant vapor phase coating may be used to derivitize glass beads for use in High Pressure Liquid Chromatography (“HPLC”) and to derivitize silica-based materials to increase hydrophilicity, such as nanocrystals to allow binding and use in biological systems. The instant coating may also be used to coat microfabricated structures such as microchips and is a potential derivitization method for the immobilization of DNA, peptides, enzymes, dyes, etc.

The following examples are for illustration purposes only and should not be used in any way to limit the appended claims.

### EXAMPLES

### Example 1

### Sequencing DNA

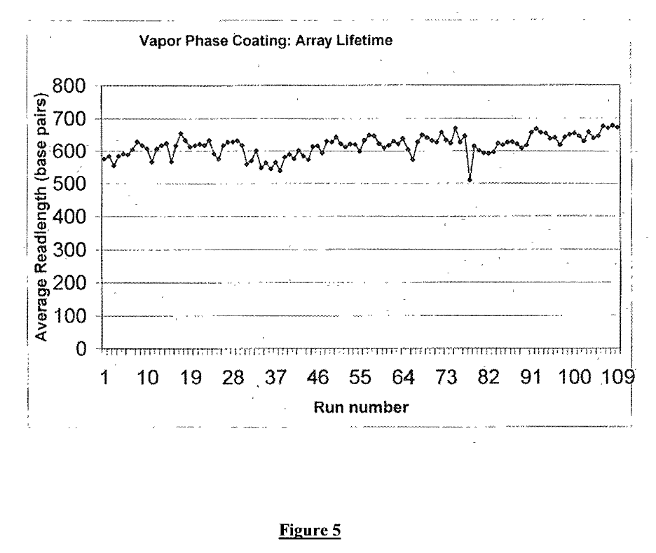

Capillary arrays were silanized and polymerized according to the procedures above. Multiple samples of the sequencing plasmid M13 were sequenced on a MegaBACE 1000 (Amersham Biosciences) and the results compared with the known sequence. The plot of average readlength in base pairs versus number of runs is shown in FIG. 5 confirms the robust performance of this wall coating for sequencing DNA.

### Example 2

### Visual Characterization of Wallcoating

This coating process can be characterized and optimized by using the essential coating process of this application with the addition of a detectable acrylic-modified molecule.

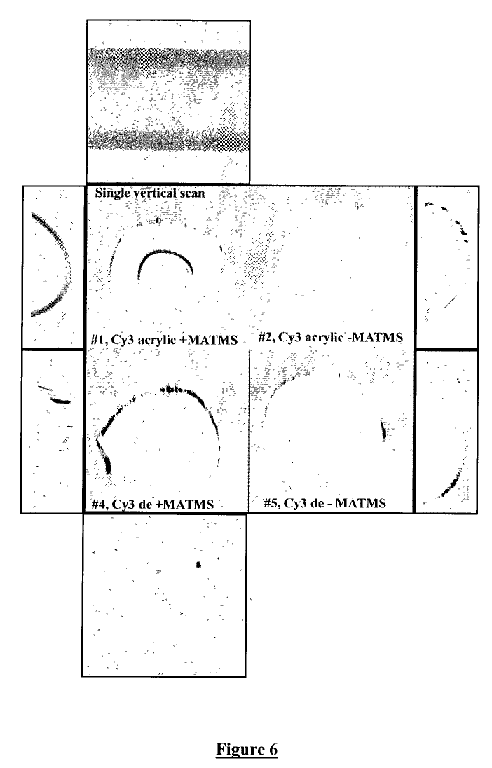

In FIG. 6, Cy3-acrylamide was copolymerized with the acrylic functionality of bifunctional silane to visualize the coating on the lumen of a transparent, glass coated-glass capillary. The addition of Cy3-acrylamide to the usual acrylamide solution was used to characterize the coverage of the usually invisible wallcoating. FIG. 6 is a collection of images acquired with a fluorescent confocal microscope (Sarastro 2000, Molecular Dynamics, Sunnyvale Calif.) configured to image the fluorescent dye Cy3 (Amersham Biosciences), signal from the dye appears black in these images. The central 4 images are optical cross sections of glass capillaries that were subjected to four different treatments. The surrounding images are projections, functionally a 2 dimensional representation of the 3 dimensional data collected by the microscope; to the left and right of the central images are projections along the long axis of the capillaries showing the inner (smaller radius) and outer (larger) surfaces. Above #1 and below #4 are projections orthogonal to the long axis showing the coating on the inner surface of the capillary. This experiment was designed to determine if the coating and copolymerization was necessary and sufficient. The four conditions shown in this example include:

#1 complete coating with a the addition of a dye (Cy3-acrylamide)

#2 no vapor-phase silanization, replace 3-methacryloxypropyl-tri methoxysilane with water.

#4 no acrylic group on dye, replace Cy3-acrylamide with Cy3-diethyl

#5 no vapor-phase silanization and no acrylic group on dye Note that only #1 has a uniform coating of the label.

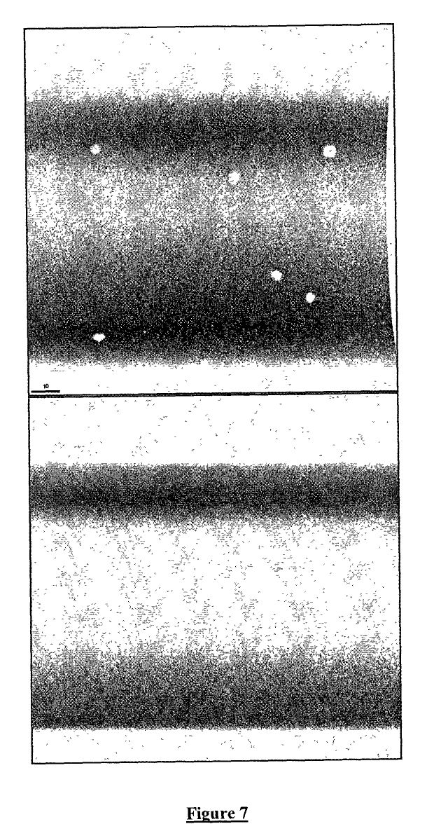

In FIG. 7 cleaning of the inside of the glass capillaries was characterized by imaging immobilized Cy3-acrylamide as above. The two conditions were: with or without pre-washing with water. The upper image is an en face, maximum intensity projection of non-washed capillary, the lower image is a capillary that was flushed with water before drying and silanizaton. The upper image shows ˜2 micron voids in the wallcoating of the un-washed capillary. The scale bar represents 10 microns and the projections were generated with the software ImageSpace™ (Molecular Dynamics).

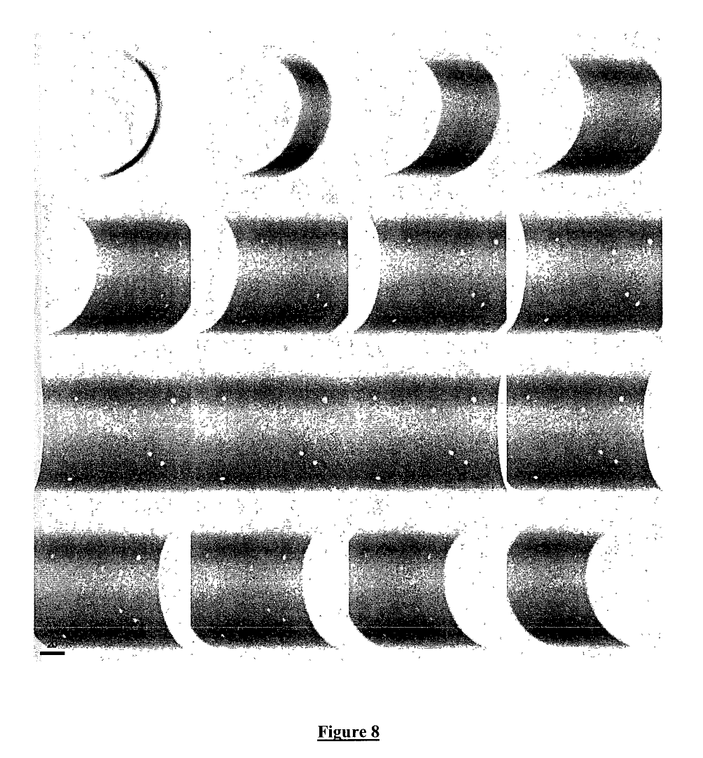

FIG. 8. Is a rotation projection series, at 10-degree increments, of the dataset shown en face in the upper panel of FIG. 2. The scale bar represents 20 microns.

Although a number of embodiments are described in detail by the above examples, the instant invention is not limited to such specific examples. Various modifications will be readily apparent to one of ordinary skill in the art and fall within the spirit and scope of the appended claims.

What is claimed is:

1. A method for coating a substrate with silane that comprises contacting in an inert environment the substrate with a vapor containing a bifunctional silane.

2. The method according to claim 1, wherein the bifunctional silane contains an acrylic functionality.

3. The method according to claim 2, further comprising the step of attaching a thin coating of linear polyacrylamide to the acrylic functionality by in-situ polymerization.

4. The method according to claim 2, further comprising the step of immobilizing acrylic-modified molecules by copolymerization with the acrylic functionality of the bifunctional silane.

5. The method according to claim 1, wherein the substrate is a glass capillary.

6. The method according to claim 1, wherein the substrate is a glass bead.

7. The method according to claim 1, wherein the substrate is a glass slide.

8. The method according to claim 1, wherein the inert environment is a nitrogen gas.

9. A method for a coating a substrate with silane that comprises contacting in an inert environment a substrate with 3-methacryloxypropyltrimethoxysilane vapor.

10. A coated substrate, coated according to the method of claim 1.

11. A method for reducing electroosmotic flow in glass capillaries used for electrophoresis that comprises:
a) contacting in an inert environment a substrate with a vapor containing a bifunctional silane containing an acrylic functionality; and
b) incorporating a thin coating of linear polyacrylamide to the acrylic functionality by in-situ polymerization.
